(19) United States
(12) Patent Application Publication
(10) Pub. No.: US 2012/0048664 A1
(43) Pub. Date: Mar. 1, 2012

(54) MULTI-CYLINDER HYDRAULIC SHOCK ABSORBER

(75) Inventors: Tomohiko Baba, Tokyo (JP); Shigeru Kojima, Tokyo (JP); Syusaku Nogami, Tokyo (JP)

(73) Assignee: KAYABA INDUSTRY CO., LTD., Tokyo (JP)

(21) Appl. No.: 13/265,561

(22) PCT Filed: Mar. 1, 2010
(86) PCT No.: PCT/JP2010/053709

§ 371 Date: Oct. 21, 2011

(30) Foreign Application Priority Data
Apr. 28, 2009 (JP) 2009-109348

(51) Int. Cl. F16F 9/06

(52) U.S. Cl. 188/269

(57) ABSTRACT

A multi-cylinder hydraulic shock absorber (D) expands and contracts in accordance with expansion and contraction of a working chamber (R1, R2) provided in a cylinder (1) and having a working fluid sealed therein. An outer periphery of the cylinder (1) is covered by an outer tube (4), and a gas chamber housing (10) projects upward from an upper end of the outer tube (4). A space between the outer tube (4) and the cylinder (1) and an inner side of the gas chamber housing (10) are used as a working fluid reservoir (5). A gas chamber (6) opposing a liquid level (S) of the working fluid is formed inside the gas chamber housing (10). With this constitution, a volume of the gas chamber (6) is secured when the multi-cylinder hydraulic shock absorber (D) is disposed horizontally while suppressing an increase in a diameter of the outer tube (4).

### FIELD OF THE INVENTION

This invention relates to a horizontally disposed multi-cylinder hydraulic shock absorber.

### BACKGROUND OF THE INVENTION

JPH08-200428, published by the Japan Patent Office in 1996, proposes a multi-cylinder hydraulic shock absorber in which a reservoir is provided between a cylinder housed in an outer tube and the outer tube.

A piston is housed inside the cylinder, and a piston rod joined to the piston projects from the cylinder to be free to slide in an axial direction. Two working chambers are defined inside the cylinder by the piston. A working fluid constituted by an incompressible fluid is charged into each working chamber. When the piston slides through the cylinder, one of the working chambers expands and the other working chamber contracts. At this time, the working oil flows from the contracting working chamber to the expanding working chamber through a passage, and a damping force is generated by a flow resistance of a damping valve provided in the passage.

To secure a stroke distance of the shock absorber, a single rod type shock absorber in which the piston rod projects from the cylinder in only one direction is preferable to a double rod type shock absorber in which the piston rod projects from the cylinder to both sides of the axial direction, and this multi-cylinder hydraulic shock absorber is a single rod type.

In a single rod type shock absorber, a total volume of the two working chambers varies according to an penetration volume of the piston rod into the cylinder. Therefore, a reservoir must be provided in a single rod type shock absorber to store surplus working fluid from the cylinder and supply working fluid to the cylinder when the amount of working fluid in the cylinder is insufficient.

Hence, this multi-cylinder hydraulic shock absorber includes the outer tube covering the cylinder coaxially therewith, and an annular gap between the outer tube and the cylinder is used as the reservoir. A gas is sealed into the reservoir together with the working fluid to compensate for variation in a volume of the working fluid in the reservoir.

### SUMMARY OF THE INVENTION

When this multi-cylinder hydraulic shock absorber is used in a so-called horizontally disposed state such that the cylinder is oriented in a horizontal direction, the reservoir must satisfy several conditions.

When the gas, which is a compressible fluid, infiltrates the fluid chambers in the cylinder, the shock absorber cannot generate an appropriate damping force, and therefore a liquid level of the reservoir must always be positioned higher than a passage connecting the reservoir to the fluid chambers in the cylinder.

Further, the gas in the reservoir contracts in accordance with the amount of fluid in the reservoir. The total volume of the two oil chambers in the cylinder reaches a minimum when the shock absorber is maximally contracted, and in this state, the amount of fluid in the reservoir reaches a maximum. Hence, when the shock absorber is maximally contracted, the gas in the reservoir is also maximally contracted. A pressure of the contracted gas acts on a seal member that is attached to a cylinder head to seal an outer periphery of the piston rod via the working fluid.

A large tightening force must be applied to the seal member so that a favorable sealing performance is maintained on the piston rod in relation to a high gas pressure. When a large tightening force is applied to the seal member, however, a sliding resistance of the piston rod increases and a durability of the seal member is adversely affected. Hence, a volume of the gas sealed into the reservoir is preferably set to be large to ensure that the pressure of the gas does not become excessive when the shock absorber is maximally contracted.

When the volume of the gas sealed into the reservoir is increased, an overall required volume of the reservoir also increases. Further, as described above, the liquid level of the reservoir must be positioned higher than the passage connecting the reservoir to the fluid chambers in the cylinder at all times. To satisfy these conditions, an outer diameter of the outer tube must be increased. As a result, large amounts of the working fluid and the gas are stored in the reservoir. For these reasons, a horizontally disposed hydraulic shock absorber tends to have a large outer diameter dimension and a large weight.

It is therefore an object of this invention to provide a single rod type multi-cylinder hydraulic shock absorber that has a small diameter and is suitable for horizontal disposal.

To achieve this object, this invention provides a multi-cylinder hydraulic shock absorber comprising a cylinder disposed such that a central axis thereof is oriented in a horizontal direction, a piston rod that expands and contracts relative to the cylinder in a central axis direction, a working chamber that expands and contracts within the cylinder in accordance with expansion and contraction of the piston rod and has an incompressible working fluid sealed therein, an outer tube covering an outer periphery of the cylinder, and a reservoir connected to the working chamber and storing the working fluid. The reservoir comprises a space between the outer tube and the cylinder, and a gas chamber housing that projects upward from an upper end of the outer tube and has a gas sealed therein.

The details as well as other features and advantages of this invention are set forth in the remainder of the specification and are shown in the accompanying drawing.

### BRIEF DESCRIPTION OF THE DRAWING

FIG. 1 is a longitudinal sectional view of a horizontally disposed single rod type multi-cylinder hydraulic shock absorber according to an embodiment of this invention.

### DESCRIPTION OF THE PREFERRED EMBODIMENT

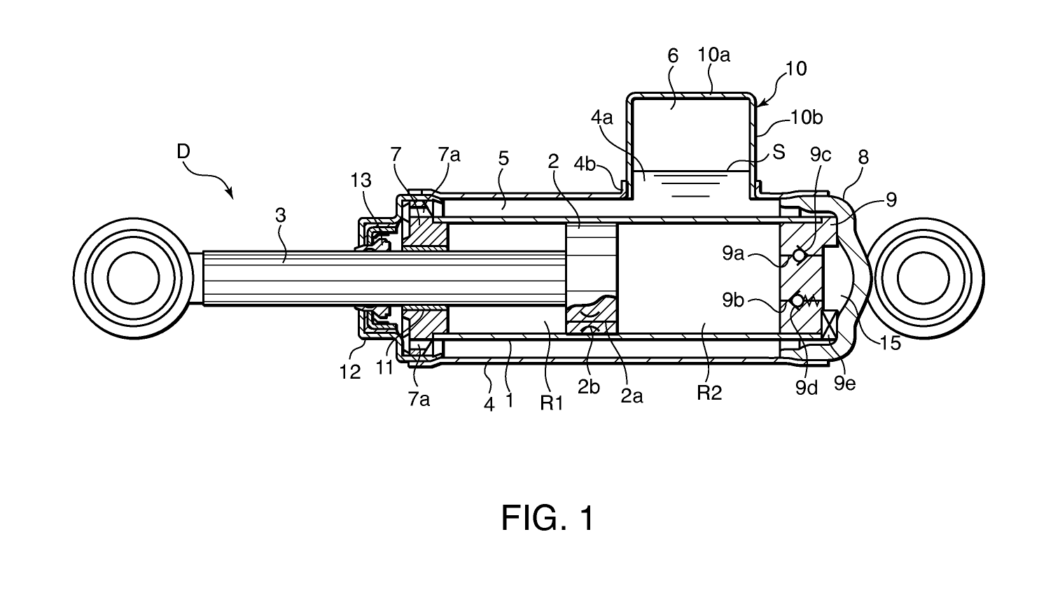

Referring to FIG. 1 of the drawing, a horizontally disposed single rod type multi-cylinder hydraulic shock absorber D according to this invention includes a cylinder 1 disposed such that a central axis thereof is oriented in a horizontal direction, a piston 2 housed in the cylinder 1, a piston rod 3 joined to the piston 2 so as to project from the cylinder 1 in an axial direction, an outer tube 4 covering an outer periphery of the cylinder 1 coaxially therewith, and a gas chamber housing 10 projecting upward from an upper end of the outer tube 4.

Eye members are fixed respectively to a projecting end of the piston rod 3 and a base end of the cylinder 1. The hydraulic shock absorber D is coupled to two members in relation to which relative vibration is to be damped, for example a vehicle body and a cabin of a vehicle, via the eye members so that the central axis of the cylinder 1 is horizontal.

A working chamber R1 positioned on a periphery of the piston rod 3 and a working chamber R2 positioned on an opposite side to the piston rod 3 are defined in the cylinder 1 by the piston 2. A working fluid constituted by an incompressible fluid such as working oil is charged into the working chambers R1 and R2. The working chambers R1 and R2 communicate via a passage 2a formed to penetrate the piston 2. An orifice 2b serving as an expansion/contraction bi-directional damping force generation element that generates a damping force by applying a resistance to a flow of the working fluid is provided in the passage 2a.

The piston rod 3 penetrates an annular rod guide 7 fixed to an end portion of the cylinder 1 at a left end of the figure. A bearing 11 that supports the outer periphery of the piston rod 3 to be free to slide is provided on an inner periphery of the rod guide 7.

A tubular seal case 12 is attached to an inner periphery of an end portion of the outer tube 4 at the left end of the figure so as to cover the rod guide 7. The piston rod 3 projects from the rod guide 7 and then projects further in the axial direction through the seal case 12. An annular seal member 13 that contacts the outer periphery of the piston rod 3 to allow the piston rod 3 to slide is held inside the seal case 12.

A space having an annular cross-section formed by an outer periphery of the cylinder 1 and the outer tube 4 positioned on an outer side of the cylinder 1 is used as a reservoir 5 for storing the working fluid.

A through hole 7a is formed to penetrate an outer edge portion of the rod guide 7 in the axial direction. The through hole 7a connects an inside of the seal case 12 to the reservoir 5. The through hole 7a is provided to recirculate working fluid that flows out of the cylinder 1 into the seal case 12 through a gap between the piston rod 3 and the bearing 11 to the reservoir 5. More specifically, when an internal pressure of the seal case 12 exceeds a pressure of the reservoir 5, the working fluid in the seal case 12 is recirculated to the reservoir 5 through the through hole 7a. Thus, the through hole 7a functions to prevent the pressure of the working fluid in the seal case 12 from rising excessively.

The base end of the cylinder 1 positioned at a right end of the figure is closed by a partition wall 9. A cap 8 covering the partition wall 9 is fixed to an inner periphery of an end portion of the outer tube 4 at the right end of the figure. The aforementioned eye member is fixed to the cap 8.

A space 15 is formed between the cap 8 and the partition wall 9. The space 15 communicates with the reservoir 5 at all times via a cutout 9e formed in a lower end of the partition wall 9. Two passages 9a and 9b connecting the working chamber R2 to the space 15 are formed to penetrate the partition wall 9. A check valve 9c that allows the working fluid to flow from the space 15 into the working chamber R2 without resistance but prohibits the working fluid from flowing in the opposite direction is provided in the passage 9a. A contraction damping valve 9d serving as a contraction damping force generation element that allows the working fluid to flow out of the working chamber R2 into the space 15 under a predetermined flow resistance but prohibits the working fluid from flowing in the opposite direction is provided in the passage 9b.

The gas chamber housing 10 is constituted by a tube portion 10b and a bottom 10a that closes one end of the tube portion 10b. The gas chamber housing 10 projects upward from the upper end of the outer tube 4 such that the tube portion 10b is positioned above the outer tube 4 of the horizontally disposed hydraulic shock absorber D and a central axis of the gas chamber housing 10 is substantially orthogonal to the central axis of the outer tube 4. An opening portion 4a is formed in advance in a corresponding position of the outer periphery of the outer tube 4. A wall surface 4b of the outer tube 4 surrounding the opening portion 4a is bent upward in advance into a substantially cylindrical shape. The gas chamber housing 10 is fixed to the outer tube 4 by inserting a tip end of the tube portion 10b into the wall surface 4b such that the bottom 10a is oriented upward and then welding the tube portion 10b to the wall surface 4b.

A gas chamber 6 into which a gas is sealed is provided inside the gas chamber housing 10. The gas chamber 6 communicates with the inside of the outer tube 4 via the opening portion 4a and forms a part of the reservoir 5. An amount of working fluid sealed into the hydraulic shock absorber D is set such that a liquid level S of the working fluid opposing the gas chamber 6 is always positioned above the passages 9a and 9b, irrespective of increases and decreases in the amount of working fluid in the reservoir 5, or in other words irrespective of expansion and contraction of the hydraulic shock absorber D. The liquid level S must be set thus to prevent the gas in the gas chamber 6 from infiltrating the cylinder 1.

More preferably, the amount of working fluid sealed into the hydraulic shock absorber D is set such that the liquid level S always rises and falls within the gas chamber 6. Thus, the gas in the gas chamber 6 can be prevented from infiltrating the cylinder 1 even when the liquid level S ripples and tilts.

When the hydraulic shock absorber D expands, the piston 2 moves through the cylinder 1 in a leftward direction of the figure such that the working chamber R1 contracts and the working chamber R2 expands. As a result, the working fluid moves from the working chamber R1 to the working chamber R2 through the passage 2a, and a damping force is generated by pressure loss accompanying the flow resistance applied by the orifice 2b. Further, when the piston rod 3 projects to the outside of the cylinder 1, a total volume of the working chamber R1 and the working chamber R2 increases. Accordingly, an amount of working fluid corresponding to the shortage of working fluid in the cylinder 1 caused by the volume increase flows into the cylinder 1 from the reservoir 5 without resistance via the passage 9a and the check valve 9c in the partition wall 9 so as to compensate for the volumetric variation in the cylinder 1. As a result, the liquid level S of the working fluid in the reservoir 5 falls such that the gas chamber 6 is enlarged. Hence, when the hydraulic shock absorber D expands, the orifice 2b generates an expansion damping force corresponding to an expansion speed.

When the hydraulic shock absorber D contracts, the piston 2 moves through the cylinder 1 in a rightward direction of the figure such that the working chamber R1 expands and the working chamber R2 contracts. As a result, the working fluid moves from the working chamber R2 to the working chamber R1 through the passage 2a, and a damping force is generated by the pressure loss accompanying the flow resistance applied by the orifice 2b. Further, when the piston rod 3 penetrates the cylinder 1, the total volume of the working chamber R1 and the working chamber R2 decreases. Accordingly, surplus working fluid in the cylinder 1 generated by the volume reduction flows into the reservoir 5 under the predetermined flow resistance through the passage 9b and the contraction damping valve 9d in the partition wall 9 and the space 15 so as to compensate for the volumetric variation in the cylinder 1. As a result, the liquid level S of the working fluid in the reservoir 5 rises such that the gas chamber 6 contracts. Hence, when the hydraulic shock absorber D contracts, the orifice 2b and the contraction damping valve 9d generate a contraction damping force corresponding to a contraction speed.

In the hydraulic shock absorber D, the contraction damping valve 9d generates the damping force during contraction, and therefore the contraction damping force does not necessarily have to be generated by the orifice 2b. For example, two one-way passages may be provided in the piston 2, an orifice or another damping force generation element may be provided in one of the passages as an expansion damping force generation element, and a check valve that allows the working fluid to flow from the working chamber R2 to the working chamber R1 without resistance but prohibits the working fluid from flowing in the opposite direction may be provided in the other passage.

In the hydraulic shock absorber D, the gas chamber housing 10 can be used as a part of the reservoir 5, and therefore a required working fluid storage amount can be secured in the reservoir 5 without increasing a diameter of the outer tube 4.

The shape of the gas chamber housing 10 is arbitrary, but by forming the gas chamber housing 10 in a closed-end tubular shape or a cup shape, the gas chamber housing 10 can be welded to the outer tube 4 easily.

In the hydraulic shock absorber D, by causing the gas chamber housing 10 to project upward from the upper end of the outer tube 4, a sufficient volume can be secured in the gas chamber 6 without increasing the diameter of the outer tube 4. Hence, even when the hydraulic shock absorber D is maximally contracted, a pressure of the gas chamber 6 does not increase excessively, and therefore a pressure acting on the seal member 13 of the piston rod 3 is not raised excessively by the pressure of the gas chamber 6. As a result, an excessive increase in a sliding resistance of the piston rod 3 caused by the pressure of the contracted gas can be prevented, and therefore the hydraulic shock absorber D operates smoothly in all stroke positions. Further, a reduction in a durability of the seal member 13 can be prevented.

According to this invention, as described above, the advantages of a single rod type hydraulic shock absorber having a short overall length can be exploited while suppressing increases in an outer diameter dimension and a weight of the shock absorber.

Further, by setting the amount of working fluid sealed into the hydraulic shock absorber D so that the liquid level S of the working fluid always varies within the gas chamber housing 10, gas infiltration into the cylinder 1 can be prevented reliably, and the amount of working fluid sealed into the hydraulic shock absorber D can be increased.

When the hydraulic shock absorber D is disposed horizontally, the gas chamber housing 10 projects from a position serving as the upper end of the outer tube 4, and therefore respective sites and disposal directions of the hydraulic shock absorber D can be associated easily during attachment to a vehicle. As a result, the hydraulic shock absorber D can be attached easily, and erroneous operations during attachment can be prevented.

The contents of Tokugan 2009-109348, with a filing date of Apr. 28, 2009 in Japan, are hereby incorporated by reference.

Although the invention has been described above with reference to certain embodiments, the invention is not limited to the embodiments described above. Modifications and variations of the embodiments described above will occur to those skilled in the art, within the scope of the claims.

For example, in the hydraulic shock absorber D described above, the orifice 2b and the contraction damping valve 9d are provided as damping force generation elements, but this invention is not dependent on the shapes and arrangements of the damping force generation elements provided in the hydraulic shock absorber D, and any resistance elements capable of generating a damping force to be applied to a flow of working fluid, such as an orifice, a choke, or a leaf valve, may be used.

The passage 2a is not limited to a single passage and may be provided in a plurality. Further, a one-way passage that allows the fluid to flow only from the working chamber R1 to the working chamber R2 and a one-way passage that allows the fluid to flow only from the working chamber R2 to the working chamber R1 may be provided in parallel.

A constitution other than that described above may be employed in relation to the gas chamber housing 10. For example, a gas chamber housing may be formed by causing the upper end of the outer tube 4 to bulge upward, and the gas chamber 6 may be provided therein. However, it is easier in terms of processing to weld the closed-end tubular or cup-shaped gas chamber housing 10 to the outer tube 4, and in this case an increase in the diameter of the outer tube 4 can be suppressed.

In the hydraulic shock absorber D, the working fluid flows bi-directionally between the working chamber R1 and the working chamber R2 through the passage 2a as the hydraulic shock absorber D expands and contracts. However, this invention may also be applied to a one-way, so-called uniflow type hydraulic shock absorber in which the working fluid flows from the working chamber R2 into a reservoir tank R via the working chamber R1 during both the expansion operation and the contraction operation, and flows into the working chamber R2 from the reservoir tank R as needed.

### INDUSTRIAL APPLICABILITY

As described above, the horizontally disposed multi-cylinder hydraulic shock absorber according to this invention is suitable for absorbing horizontal direction vibration between a vehicle body and an axle of a vehicle, but is not limited to this application.

The embodiments of this invention in which an exclusive property or privilege is claimed are defined as follows:

1. A multi-cylinder hydraulic shock absorber comprising:
a cylinder disposed such that a central axis thereof is oriented in a horizontal direction;
a piston rod that expands and contracts relative to the cylinder in a central axis direction;
a working chamber that expands and contracts within the cylinder in accordance with expansion and contraction of the piston rod and has an incompressible working fluid sealed therein;
an outer tube covering an outer periphery of the cylinder; and
a reservoir connected to the working chamber and storing the working fluid, the reservoir comprising a space between the outer tube and the cylinder, and a gas chamber housing that projects upward from an upper end of the outer tube and has a gas sealed therein.

2. The multi-cylinder hydraulic shock absorber as defined in claim 1, further comprising a passage that connects the reservoir to the working chamber,
wherein a liquid level forming a boundary between the gas and the working fluid in the reservoir is always positioned above the passage, regardless of an expansion/contraction state of the multi-cylinder hydraulic shock absorber.

3. The multi-cylinder hydraulic shock absorber as defined in claim 2, wherein the liquid level always exists inside the gas chamber housing.

4. The multi-cylinder hydraulic shock absorber as defined in claim 1, further comprising:
a piston that is joined to the piston rod so as to slide through the cylinder in the central axis direction, wherein the working chamber is defined on an opposite side of the piston to the piston rod as a second working chamber;
a first working chamber defined on a periphery of the piston rod by the piston wherein the piston comprises a damping force generation element that allows the working fluid to flow bi-directionally between the first working chamber and the second working chamber while applying a resistance thereto;
a damping force generation element that allows the working fluid to flow out of the second working chamber into the reservoir while applying a resistance thereto; and
a check valve that allows the working fluid to flow in an opposite direction without resistance.

5. The multi-cylinder hydraulic shock absorber as defined in claim 1, wherein the gas chamber housing is formed in a closed-end tubular shape and fixed by welding to a periphery of an opening portion formed upwardly in an upper end of the outer tube.
